(19) United States
(12) Patent Application Publication
(10) Pub. No.: US 2013/0273559 A1
(43) Pub. Date: Oct. 17, 2013

(54) PROCESS FOR PREPARING A CHEMICAL STRUCTURE HAVING A PHASE PARTITION, CAPABLE OF GENERATING A SPECIFIC FLUORESCENCE SPECTRUM AND USES THEREOF

(71) Applicants: Didier Tousch, Montpellier (FR); Thomas Olivier, Saint Etienne (FR); Fabrice Taly, Montpellier (FR); Alain Thierry, Montpellier (FR)

(72) Inventors: Didier Tousch, Montpellier (FR); Thomas Olivier, Saint Etienne (FR); Fabrice Taly, Montpellier (FR); Alain Thierry, Montpellier (FR)

(73) Assignee: CENTRE NATIONAL DE LA RECHERCHE SCIENTIFIWUE (CNRS), Paris (FR)

(21) Appl. No.: 13/824,679

(22) PCT Filed: Sep. 29, 2011
(86) PCT No.: PCT/EP2011/067056

§ 371 Date: Jul. 3, 2013

(30) Foreign Application Priority Data
Sep. 29, 2010 (FR) 1057855

(51) Int. Cl. G01N 21/64

(52) U.S. Cl. CPC G01N 21/6486
USPC 435/7.1; 436/501

(57) ABSTRACT

The subject matter of the invention is a process for preparing an assembled chemical structure or a mixture of such structures, this structure having a phase partition, wherein the phases are in particular of hydrophobic and hydrophilic nature, such as a composite/synthetic particle or a liposome, and being capable of generating an original fluorescence spectrum. The subject matter of the invention is also said assembled structures and mixture thereof and also the compositions or kit comprising same. The invention also relates to the use of these assembled structures and mixture thereof, in particular for medical imaging in vivo or for in vitro diagnosis of a pathological condition, but also for labelling a sample, an object or a composition that is liquid, or for authentification thereof. The invention also comprises the objects or liquids labelled with the assembled structures, a mixture thereof or with the compositions according to the invention.

The subject matter of the invention is a process for preparing in phase partition a fluorescent assembled chemical structure, specific in that each phase of the partition solubilises and physically separates fluorescent molecules into separate compartments as for a particle or a liposome. The invention also relates to said assembled structures and mixture thereof as well as the compositions or kit comprising same. The invention also relates to the use of said assembled structures and mixture thereof, in particular for in vivo medical imaging or for in vitro pathology diagnosis, but also for labelling a sample, an object or a liquid composition or for the authentication thereof. The invention also comprises objects or liquids labelled with the assembled structures, mixtures thereof or by the compositions according to the invention.

Fluorescence is the property that certain bodies possess of emitting light after having absorbed photons of higher energy. A fluorescent molecule (fluorophore or fluorochrome) possesses the property of absorbing luminous energy (excitation light) and returning it rapidly in the form of fluorescent light (emission light). The light reemitted by the excited molecule may be of same wavelength (resonance fluorescence) or of higher wavelength (in liquid media) or lower. This shift of the emission spectrum towards higher wavelengths largely facilitates the separation and the detection of the fluorescence light. There exists a large choice of organic, natural or synthetic (fluorescein) fluorochromes; each fluorochrome being able to be characterised by its excitation and emission spectra. Biological labelling for medical diagnosis or imaging has widely developed the use of these fluorescent molecules. Fluorescence microscopy is based on the formation of an image by detection of this emitted light (Huang B et al., 2009). Numerous labelling techniques are used:
simple labelling takes place by affinity between a fluorochrome and the molecule to be labelled,
immunolabelling, which involves an antibody labelled with a fluorochrome,
the FISH technique, which serves to label nucleotide sequences,
   the use of fusion proteins (typically GFP (for green fluorescent protein) consists in introducing into the cell to be observed a gene encoding a fluorescent recombinant protein,
FLIP and FRAP consist in irradiating a zone in which the fluorescence is going to disappear. These techniques make it possible to study the scattering of the labelled molecules,
FRET (Fluorescent Resonance Energy Transfer) uses two fluorochromes, a donor that is going to transmit its energy to another acceptor fluorochrome. It makes it possible to study interactions between two molecules,
BRET (Bioluminescence Resonance Energy Transfer) is a phenomenon similar to FRET with the difference that the donor is bioluminescent (luciferase).

To highlight non-fluorescent substances or molecules in structures of living matter, it is possible to carry out a direct labelling by said fluorochromes, such as for example DAPI which labels DNA, but often the labelling is indirect, in other words the fluorescent molecule is itself attached to a molecule that will reveal the searched for target such as specific antibodies for example.

Fluorescent molecules are also used in other applications, such as the labelling of an object, the labelling of an ink, etc. They are powerful identification tools thanks to their specific physical properties.

There exists however numerous limits to the use of these fluorescent molecules. Their great instability for example, and their photo-bleaching where the fluorochrome loses said fluorescence properties. More recently, fluorescent molecules have been used by mixing by encapsulation in particles of polymer(s) (Forn [symbol] sek L and V\check{e}tvicka V, 1986). A new generation of fluorescent minerals (nanocrystals) often known as “quantum dot”, very stable and with very low photo-bleaching compared to preceding molecules, now form part of a new generation of molecular labels (Sukhanovaa et al., 2004). Many other applications have now been developed such as LED (Light-Emitting Diode) for example (Burroughes J H et al., 1990). However the present arsenal does not yet enable all of the problems of labelling to be met.

Thus, novel labels capable of generating an original fluorescence spectrum are still required.

This is precisely the subject matter of the present invention.

The inventors have highlighted that it is possible to combine in assembled structures in phase partition different fluorescent molecules, the physical-chemical properties of which do not enable their miscibility in a same solvent. Said structures have separate compartments in which are distributed the fluorescent molecules combined according to their miscibility, which has the effect of generating a resulting specific and unexpected fluorescence, in particular in that said resulting fluorescence is not the simple consequence of the mixing of fluorescent molecules. These assembled structures or a mixture of such structures are capable of generating a specific and unexpected fluorescence spectrum. This effect now being revealed, the process that is the subject matter of the present invention makes it possible to obtain assembled chemical structures in phase partition capable of generating specific fluorescences such as composite particles or liposomes enabling two reading levels:
either the combined reading of the two fluorescent molecules generating a unique reemission of fluorescence; or
or when it involves for example particles, a separate and simultaneous reading with a fluorescence specific to the shell or wall of the particle and a fluorescence specific to the content. This leads to an enormous diversity of labelling and possible combinations for the traceability of objects.

Thus, under a first aspect, the subject matter of the present invention is a process for preparing in partition phase an assembled chemical structure capable of generating a specific fluorescence signal, said phase partition between a first phase and a second phase not miscible together structuring a first compartment and a second compartment, said compartments not being miscible together, said process comprising the following steps:

a) the preparation of said first phase and said second phase not miscible with the first;

b) the formation of said assembled chemical structure having as consequence of the phase partition a first compartment and a second compartment not miscible together,

characterised in that said first compartment contains a composition comprising at least one miscible compound capable of generating a fluorescence and said second compartment contains a composition comprising at least one miscible compound capable of generating a fluorescence.

Under a particular aspect, the invention also comprises a process for preparing in partition phase an assembled chemical structure having a compartmentation capable of generating a specific fluorescence signal in partition phase, said phase partition delimiting a first compartment and a second compartment, said first compartment and said second compartment not being miscible together, said process comprising the following steps:

a) the preparation of the first phase and the non-miscible second phase; and

b) the formation of said assembled chemical structure having as consequence of the phase partition a first compartment and a second compartment not miscible together,

characterised in that said first compartment contains a composition comprising at least one compound miscible in said first phase capable of generating a fluorescence and the second compartment contains a composition comprising at least one compound miscible in said second phase capable of generating a fluorescence, and in which process said first and second phases have been mixed with a third phase containing fluorescent compounds either for some miscible with the first phase, or instead for others miscible with the second phase.

In the process according to the invention, at step a) the preparation of said first phase and of said second phase will be carried out by processes well known to those skilled in the art as a function of the chemical structures chosen and the assembled chemical structure in phase partition that it is wished to obtain from said two chemical structures.

In general, said assembled chemical structure is selected from an assembled structure in phase partition or separation between at least two phases not miscible together.

As example of assembled chemical structure, but without being limited thereto, one may cite the emulsion (in particular water/oil or oil/water), structures assembled with the aid of amphiphilic macromolecules, laminate films, gels, liposomes or micro- or nanoparticles.

Among emulsions, one may cite in particular emulsions of squalene-pluronic L35-Phosphatidylcholine-surfactant or instead lecithin-phospholipids-surfactant type (Watrobska-Swietlikowska D and Sznitowska M, 2006). These are mixtures proposed for the delivery of drugs of hydrophobic nature. A series of methods for obtaining emulsions are proposed in the review of He C. X., He Z. G. and Gao J. Q. Expert Opin Drug Deliv, April 7 (4): 445-60 (2010) Microemulsions as drug delivery systems to improve the solubility and the bioavailability of poorly water-soluble drugs.

Among amphiphilic macromolecules, one may cite in particular amphiphilic macromolecules of sodium dodecyl sulphate, poly(gamma-glutamic acid) (Akao T et al., 2010), poly(propylenimine) dendrimer type (Chooi K W et al., 2010).

Among gels, one may cite in particular gels of hydrogel type such as copolymers of alkyl(meth)acrylates (Black J K et al., 2010) or copolymers of polyethylene-oxide and ethylene-oxide (PEO-b-PPO) (Sakai T et al., 2010).

Among stratified films, one may cite in particular laminate films of “scaffold” type, in other words stacked layers, made of monolayers manufactured from inorganic materials (Hench and Polak, 2002) such as calcium phosphate or organic materials such as natural or synthetic polymers ( ). Among natural polymers, hydrogels based on biopolymers, such as alginate and chitosan are widely recommended. There are “Langmuir-Blodgett” films which consist in constructing a monolayer film by the deposition of surfactant or amphiphilic molecules, at an air/water interface. This monolayer is then transferred onto a solid support by soaking it in the sub-phase. The adsorption is based on hydrophilic/hydrophobic type interactions. A second immersion of the slide leads to the adsorption of a second layer then repeated several times in succession. There is also the manufacture of multilayer films by the use of polycations (Hoogeveen et al., 1996).

A good number of techniques for obtaining these laminate films are described by H. Mjahed H. (PhD thesis, University of Strasbourg. Defended in October 2009. “Caractérisation physico-chimique des films multicouches de polyélectrolytes à base de polysaccharides et de polypeptides en vue d'applications dans le domaine des biomatériaux” (Physical-chemical characterisation of multilayer polyelectrolyte films based on polysaccharides and polypeptides for applications in the biomaterials field).

In particular, the author cites harder and denser linear growth multilayer films, which do not enable the diffusion of molecules, thus playing the role of a barrier. They can play the role of reservoir enabling films with compartments to be formed. Such architectures have been produced by depositing for example poly(allylamine)/poly(styrene sulphonate) films on other films of poly(L-lysine)/hyaluronic acid type.

The following steps of the process of the invention will be determined and adapted as a function of the assembled chemical structure that it is wished to obtain and having this phase partition:

a) the preparation of said first phase and said second phase; and

b) the formation of said chemical structure having a phase partition generated beforehand by mixing or self-structured.

Once the assembled chemical structure is selected, the method or process aiming to obtain it will be selected from standard methods or processes to obtain said structures, which are well known to those skilled in the art.

In a particularly preferred embodiment, the subject matter of the invention is a process for preparing an assembled chemical structure according to the present invention, characterised in that said phase partition delimits a first phase of hydrophobic nature (hydrophobic phase) and a second phase of hydrophilic nature (hydrophilic phase), said process then comprising the following steps:

a) the preparation of the first phase of hydrophobic nature not miscible with water and the second phase of hydrophilic nature; and

b) the formation of said assembled chemical structure in partition phase obtained beforehand by mixing or self-structured,

characterised in that:
said hydrophobic phase contains a composition comprising at least one hydrophobic compound capable of generating a fluorescence (known as hydrophobic fluorescent compound) and said hydrophilic phase contains a composition comprising at least one hydrophilic compound capable of generating a fluorescence (known as hydrophilic fluorescent compound)
said first and second phases are mixed with a third amphiphilic phase, miscible with the first two phases, containing fluorescent compounds miscible either with the first phase, or instead with the second phase. In a more particularly preferred embodiment, the subject matter of the invention is a process for preparing an assembled chemical structure according to the present invention, characterised in that said process is a process for preparing microparticles or nanoparticles capable of generating a specific fluorescence signal, said microparticles or nanoparticles comprising a rigid or fluid wall delimiting at least one intra-particular space, said wall being of hydrophobic nature and said intra-particular space being occupied by an aqueous solution, or, conversely said wall being of hydrophilic nature and said intra-particular space being occupied by a solution of hydrophobic nature, said process implementing a process for preparing microparticles or nanoparticles comprising the following steps:

a) the preparation of an organic solution not miscible in water (known as hydrophobic solution) and an aqueous solution;

b) the formation of the phase partition by mixing and emulsification of the hydrophobic solution with the aqueous solution; and

c) the formation of said particles, characterised in that:
said hydrophobic solution contains a composition comprising at least one hydrophobic compound capable of generating a fluorescence (known as hydrophobic fluorescent compound) and the hydrophilic solution contains a composition comprising at least one hydrophilic compound capable of generating a fluorescence (known as hydrophilic fluorescent compound); or
said hydrophobic solution and hydrophilic solution are mixed with a third amphiphile containing a composition comprising at least one hydrophobic fluorescent compound and at least one hydrophilic fluorescent compound such that the mixing of the three solutions generates a phase partition between a hydrophilic phase containing at least one hydrophilic fluorescent compound and a hydrophobic phase containing at least one hydrophobic fluorescent compound.

Microparticles or nanoparticles is taken to designate in particular any particle, whether of composite or synthetic type or instead of liposome type, preferably cylindrical, of ovoid or spherical shape, of diameter comprised between 10 nm and 1 μm for nanoparticles and 1 to 500 μm for microparticles, preferably of diameter comprised between 30 nm for nanoparticles and 50 μm for microparticles. There exists a large number of different types of microparticles or nanoparticles comprising in general a rigid or fluid wall delimiting at least one intra-particular space.

Among said microparticles or nanoparticles may be cited in particular but without being limited thereto the following microparticles or nanoparticles:
polycaprolactone, polymethyl methacrylate (Eudragit or Pluronic® such as Pluronic®P6100 or L92,
nanoparticles of latex (Cartier R et al., 2007), viscose, cellulose and chitosan,
nanoparticles of proteins,
nanoparticles with metal core,
nanoparticles formed of a mixture of the different aforementioned polymers (polymethacrylate, polystyrene for example).

The articles of Caldorera-Moore M et al., Expert Opin Drug Deliv. April; 7(4):479-95 (2010) Designer nanoparticles: incorporating size, shape and triggered release into nanoscale drug carriers, of Giouroudi I and Kosel J. Recent Pat Nanotechnol. June; 4(2):111-8 (2010) Recent progress in biomedical applications of magnetic nanoparticles or Freitas S et al. in Journal of Controlled Release vol. 102, Issue 2, pp 313-332 (2005) Microencapsulation by solvent extraction/evaporation: reviewing the state of the art of microsphere preparation process technology, describe these technologies for obtaining composite particles.

Among those in which the wall (or shell) is of hydrophobic nature and said intra-particular space may be occupied by an aqueous solution, one may cite in particular but without being limited thereto the following microparticles or nanoparticles:
polycaprolactone, polymethyl methacrylate, Eudragit or Pluronic® such as Pluronic®P6100 or L92.

According to a preferred embodiment of the invention, said nano- or microparticle may be composed of at least one polymer which may be selected from the group comprising polycaprolactone, polymethyl methacrylate, Eudragit or Pluronic® such as Pluronic®P6100 or L92, preferably polymethyl methacrylate, a mixture of polymethyl methacrylate and polycaprolactone, a mixture of polymethyl methacrylate and Pluronic® and even more preferentially polymethyl methacrylate. Among preferred natural polymers, one may cite latex, chitosan, cellulose and viscose.

Among those in which the wall (or shell) is of hydrophilic nature and said intra-particular space may be occupied by a lipidic solution, one may cite in particular but without being limited thereto microparticles or nanoparticles of latex, viscose, cellulose and chitosan.

Such supports are well known to those skilled in the art and may be obtained with the aid of processes of encapsulation by evaporation of solvent (emulsion/precipitation), by coacervation, by interfacial polymerisation, by nebulisation, by drying, by spraying, by fluidised bed coating, by gelling, by congealing of drops, in a preferred manner by evaporation of solvent. These processes are described in particular in the following articles: Abrant A et al., Eur. polym. J., 37, 955-963, (2001) “Microencapsultation par évaportation de solvent” (Microencapsulation by evaporation of solvent); Taverdet J L. et al., Ann. Fais. Exp. Chim., 94, 955, 103-113 (2001) Microencapsulation de matière active par coacervation complexe: influence de certains factors sur la vitesse de libération (Microencapsulation of active material by complex coacervation: influence of certain factors on the rate of release); Fugit J L. and al., Polymer Int., 52, 670-675, (2003) Treatment of a plasticized PVC to reduce plasticizer/solvent migration: optimization with an experiment design; Ponsart S et al. Eur. J. Sci. 4 Suppl. S75-S76, 996 (2004) These processes are also described in the following works: The Science and Engineering of Thermal Spray Coatings of Lech Pawlowski et al., Journal of Thermal Spray Technology, ASM International, vol. 13, no 1, March.

Thus, according to a preferred embodiment, the subject matter of the invention is a process for preparing microparticles or nanoparticles according to the invention, characterised in that said microparticles or nanoparticles are composites/synthetic particles and in that the process implemented for the preparation of said microparticles or nanoparticles is selected from:
the process of precipitation of polymers such as for example by de-solvation or single emulsion-evaporation of solvent;
the process of radial polymerisation from a metal core with random or ordered ramifications (the dendrimer),

these processes enabling the synthesis of solid particles (pellets) sometimes bipolar (with a hydrophobic surface and a hydrophilic core) charged with said at least hydrophobic fluorescent compound, and
the process of double emulsion-evaporation of solvent;
the process of chemical cross-linking of natural macromolecules;
the process of interfacial polymerisation,

these processes enabling the encapsulation in said particles of said at least hydrophobic fluorescent compound or of said at least hydrophilic compound, or instead of said hydrophobic and hydrophilic compounds.

According to an also preferred embodiment, the subject matter of the invention is a process for preparing microparticles or nanoparticles, characterised in that the process implemented for the preparation of microparticles or nanoparticles is the process of double emulsion-evaporation of solvent, and in that said hydrophobic solution is constituted of a solution selected from:
a solution of polymethyl methacrylate (PMMA) dissolved in dichloromethane;
Pluronic® dissolved in ethanol;
polycaprolactone dissolved in acetone; or
polystyrene dissolved in limonene or chloroform.

In a particularly preferred embodiment, the subject matter of the invention is a process for preparing microparticles or nanoparticles according to the invention, characterised in that said hydrophobic solution is constituted of a solution selected from:
a solution of polymethyl methacrylate (PMMA) dissolved in dichloromethane;
a solvent containing pure or in mixture at least one hydrophobic fluorescent substance;
an aqueous solution containing pure or in mixture at least one hydrophilic fluorescent substance.

In these conditions, two successive sonications are carried out, the first by mixing of the solvent and the aqueous solution then the second by mixing the first emulsion with an aqueous solution/0.1 PVA. The latter is then poured into 200 mL of a 1% PVA solution and the mixture is placed immediately under a strong agitation which will enable the evaporation of the dichloromethane.

Under another aspect, the subject matter of the invention is a process for preparing microparticles or nanoparticles according to the invention, characterised in that said microparticles or nanoparticles are liposomes and the process implemented for the preparation of microparticles or nanoparticles is a process for preparing liposomes, in particular implementing as hydrophobic solution a concentrate of phospholipids.

Here again, the standard processes for preparing liposomes are well known to those skilled in the art and will not be explained here in an exhaustive manner. One may nevertheless cite in particular, but without being limited thereto, the standard processes for preparing liposomes such as:
injection of ethanol into water
preparation by sonication
preparation by membrane exclusion
preparation by lyophilisation
preparation by freezing unfreezing
preparation by reverse phase evaporation
solubilisation of detergents, etc.

These methods producing either multilamellar or unilamellar vesicles of very varied sizes (50 to 1090 nanometres).

These technologies are discussed in the review article of Walde P et al., Chembiochem May 3; 11(7):848-65 (2010) Giant vesicles: preparations and applications.

In a preferred embodiment, the subject matter of the invention is a process for preparing assembled chemical structure or, preferably, microparticles or nanoparticles, according to the invention, characterised in that:
said composition comprising at least one compound miscible in the first structure capable of generating a fluorescence or said composition comprising at least one compound miscible in the second structure capable of generating a fluorescence; or
said composition comprising at least one hydrophobic compound capable of generating a fluorescence or said composition comprising at least one hydrophilic compound capable of generating a fluorescence,

is selected from the group constituted of a synthetic or natural, plant or animal extract, or a mixture of synthetic and/or natural extracts, an isolated or purified hydrophobic or hydrophilic compound capable of generating a fluorescence, or in a mixture of said isolated or purified compounds.

For example natural, plant or animal extract, capable of generating fluorescence, is taken to mean any structure, substance, or mixture thereof, present in an organism belonging to the animal or plant kingdom and in which extract or mixture is contained at least one natural compound capable of generating a fluorescence, in particular under ultraviolet.

Synthetic extract is taken to mean any structure or substance present in an organism belonging to the animal or plant kingdom but the synthesis of which has been realised by chemical synthesis.

By way of examples of natural extract of plant origin, may be cited extracts of plants, seeds, grains of pollen or plant spores.

In another preferred embodiment, the subject matter of the invention is a process for preparing assembled chemical structure or, preferably, microparticles or nanoparticles, according to the invention, characterised in that said composition comprising at least one hydrophobic fluorescent compound is constituted essentially of the hydrophobic part of a plant or animal extract, or a mixture thereof, and in that said composition comprising at least one hydrophilic fluorescent compound is constituted essentially of the hydrophilic part of a plant or animal extract, or a mixture thereof.

Fluorescent compound is herein taken to mean in particular compounds capable of generating a fluorescence after submission to a radiation, in particular of ultraviolet type.

In another preferred embodiment, the subject matter of the invention is a process for preparing assembled chemical structure or, preferably, microparticles or nanoparticles, according to the invention, characterised in that said hydrophobic part and said hydrophilic part are taken from the same extract or from two separate extracts.

Under a novel aspect, the subject matter of the present invention is a process for preparing a mixture of at least two assembled chemical structures and in a preferred manner a mixture of at least two microparticles or nanoparticles capable of generating an original fluorescence signal that is significantly different (capable of being distinguished from each other), each of said assembled chemical structures or said microparticles or nanoparticles being obtained by a process for preparing assembled chemical structure or microparticles or nanoparticles according to the present invention, characterised in that:
one at least of the compounds capable of generating a fluorescence and miscible in the first phase, and one at least of the compounds capable of generating a fluorescence and miscible in the second phase is different between said two assembled structures; or
one at least of the hydrophobic or hydrophilic fluorescent compounds contained in said particle is different between said two particles.

In a particular embodiment, according to a preferred embodiment, the subject matter of the invention is a process for preparing a mixture of at least n assembled chemical structures or for preparing a mixture of at least n microparticles or nanoparticles (n designating the number of types of assembled structures or nano- and microparticles) capable of generating an original fluorescence signal that is significantly different between said n assembled structures or particles, each of said assembled structures or microparticles or nanoparticles being obtained by a process according to the present invention, characterised in that it implements for each of said assembled structures or particles a composition in compounds capable of generating a fluorescence different for each of said assembled structures or particles, and in that n is greater than or equal to 2, preferably to 3, 4, 5, 6, 7, 8, 9 or 10.

Under yet another novel aspect, the subject matter of the present invention is the assembled chemical structures or microparticles or nanoparticles, or mixture of assembled structures or microparticles or nanoparticles, capable of generating an original fluorescence signal or an original fluorescence spectrum, obtained or capable of being obtained by a process according to the present invention.

Under yet another novel aspect, the subject matter of the present invention is a mixture of at least n microparticles or nanoparticles, capable of generating an original fluorescence signal different between each of said particles, characterised in that each of said particles comprises:
a rigid or fluid wall delimiting at least one intra-particular space, said wall being of hydrophobic nature and said intra-particular space being occupied by an aqueous solution, or, conversely said wall being of hydrophilic nature and said intra-particular space being occupied by a solution of hydrophobic nature;
i) when said rigid or fluid wall is of hydrophobic nature and said intra-particular space is of hydrophilic nature, said wall comprises at least one hydrophobic fluorescent compound and said intra-particular space comprises at least one hydrophilic fluorescent compound,
ii) when said rigid or fluid wall is of hydrophilic nature and said intra-particular space is of hydrophobic nature, said wall comprises at least one hydrophilic fluorescent compound and said intra-particular space comprises at least one hydrophobic fluorescent compound; and in that:

for each of said n microparticles or nanoparticles, one at least of the hydrophobic or hydrophilic fluorescent compounds contained in said rigid or fluid wall and/or in said intra-particular space is different between said n particles,

n being greater than or equal to 2, preferably to 3, 4, 5, 6, 7, 8, 9 or 10.

In a preferred manner, when it involves particles, said particles are selected from composites/synthetic particles or from liposomes, in particular as described for the above processes according to the present invention.

Also in a preferred manner, the subject matter of the invention is a mixture of at least n microparticles or nanoparticles, said particles being capable of generating a specific fluorescence signal according to the present invention, characterised in that said particles of said mixture are particles, the rigid or fluid wall of which is of hydrophobic nature and the intra-particular space is of hydrophilic nature.

Also in a preferred manner, the subject matter of the invention is a mixture of at least n microparticles or nanoparticles, capable of generating an original fluorescence signal according to the present invention, in which mixture said particles are synthetic particles, the wall of which is constituted essentially of polymers selected from polymethyl methacrylate (PMMA), polystyrene, latex, chitosan, cellulose and viscose.

Also in a preferred manner, the subject matter of the invention is a mixture of at least n microparticles or nanoparticles capable of generating an original fluorescence signal according to the present invention, characterised in that
said composition comprising at least one compound miscible in the first phase capable of generating a fluorescence or said composition comprising at least one compound miscible in the second phase capable of generating a fluorescence; or
said composition comprising at least one hydrophobic compound capable of generating a fluorescence or said composition comprising at least one hydrophilic compound capable of generating a fluorescence,

is selected from the group constituted of a synthetic or natural, plant or animal extract, or a mixture of synthetic or natural extracts, an isolated or purified hydrophobic or hydrophilic compound capable of generating a fluorescence, or a mixture of said isolated or purified compounds.

In an also preferred embodiment, the subject matter of the invention is a mixture of at least n microparticles or nanoparticles capable of generating an original fluorescence signal according to the present invention, in which mixture, characterised in that said composition comprising at least one hydrophobic compound capable of generating a fluorescence is constituted essentially of the hydrophobic part of a plant or animal, natural or synthetic extract, or a mixture thereof, and in that said composition comprising at least one hydrophilic compound capable of generating a fluorescence is constituted essentially of the hydrophilic part of said plant or animal extract, or a mixture thereof.

In an also preferred embodiment, the subject matter of the invention is a mixture of at least n assembled structures or n microparticles or nanoparticles according to the present invention, characterised in that said hydrophobic part and said hydrophilic part within a same particle are taken from the same extract or from two separate extracts.

Under yet another novel aspect, the subject matter of the present invention is a composition for the in vivo diagnosis or for in vivo medical imaging, characterised in that it comprises a mixture of at least n assembled structures or n microparticles or nanoparticles according to the present invention.

In a preferred embodiment, the composition according to the invention is characterised in that, when it involves in particular particles, the external wall of said particle is labelled with the aid of a label specific to the biological tissue or to the cell, or one of the elements thereof that it is wished to observe or highlight, each of the n particles being labelled with the aid of a different label between each of particles.

Among the specific labels of biological tissue or the cell, one may cite but without being limited thereto any compound capable of specifically recognising a particular structure or a compound of said tissue or of said targeted cell, such as in particular an antigen or a receptor expressed at the external surface of said cells, the specific label then being able to be but without being limited thereto an antibody directed against said antigen or a ligand specific to said receptor.

Under yet another novel aspect, the subject matter of the present invention is a kit necessary for in vivo diagnosis or for in vivo medical imaging, characterised in that said kit comprises a mixture of at least n assembled structures or n microparticles or nanoparticles according to the present invention, each of the assembled structures or particles being preferably labelled with a different label.

Preferably, said label is a biological label capable of attaching itself specifically onto the element that it is wished to highlight or observe, in particular an antibody directed specifically against said element.

Under yet another novel aspect, the subject matter of the present invention is a process for labelling a sample or an object characterised in that one places in contact said sample or object with a mixture of n assembled structures or n microparticles or nanoparticles according to the present invention.

In the process for labelling a sample or an object according to the invention, preferably the object is comprised in the group of objects constituted of a work of art, technical parts of high added value, manufactured objects.

By way of examples of object, one may further cite perfume bottles, bottles such as wine bottles, packaging, bank notes, clothing, watches, electrical goods, books, passports, medicines, chemical formulations, foodstuffs such as meat, perfumes, wines, articles based on canvas, paper, plastic, inks, paint.

The labelling of object, composition or sample according to the invention may take place in any appropriate manner that does not cause modification of the characteristics of said objects, compositions or sampled such as the morphological or biological characteristics (if it involves biological materials).

By way of example, the labelling can take place by bonding or varnishing if the support of the composition used is respectively an adhesive or a varnish.

Preferably here, the adhesives or varnishes will be selected from adhesives or varnishes little or not at all fluorescent, or in that said adhesives or varnishes do not hinder the interpretation of the essential signal such as for example cellulose, polymethyl methacrylate (PMMA), latex.

When the support of the composition is a particle and the object or composition to be labelled is a fluid, the labelling may be carried out by a mixing operation. When the support of the composition is a particle and the object is a paste or a solid, the labelling may be carried out by including the mixture of said particles during the manufacture of the solid, such as a paste, a fabric, a canvas (for a painting), glass or for any material useful for the manufacture of an object.

Preferably here, said solids will preferably be selected from neutral solids in terms of fluorescence emission, in other words from materials little or not at all fluorescent, or instead in that said materials do not hinder the interpretation of the essential fluorescence signal resulting from the phase partition.

By way of examples, when the support of the composition is a particle, the labelling may be carried out by:
the mixing of a composition according to the invention with an ink or a composition of ink vehicle or with water or a combination of water and organic solvent and the impression directly on a product, or
the immersion of at least one part of the surface of the object to be labelled in a solution comprising a composition according to the invention to attach, for example by adsorption, said composition onto the product, or
the mixing of at least one composition according to the invention with a colorant material or a paint intended to be used with a product, or
the addition of a composition according to the invention directly to solutions or formulations of chemicals such as drugs or foodstuffs.

Advantageously, the labelling according to the invention may be carried out by spraying. The spraying may take place for example with the aid of a device with a nozzle for the labelling of numerous products or with the aid of an “aerosol” type device.

Under yet another novel aspect, the subject matter of the present invention is a process for labelling a liquid composition characterised in that one incorporates in said composition a mixture of assembled structures or n microparticles or nanoparticles according to the present invention, in particular said composition being selected from an ink, an injectable liquid or a nutritive solution.

Under yet another novel aspect, the subject matter of the present invention is a process for diagnosing in particular a pathology or a stage of advancement or regression of a pathology, from a biological sample, characterised in that it implements a step in which one places in contact a mixture of n assembled structures or n microparticles or nanoparticles according to the present invention with said sample and in that one observes or analyses the fluorescence spectrum emitted by the sample thereby labelled, in particular at the level of certain elements of the sample, preferably from a biopsy.

Under yet another novel aspect, the subject matter of the present invention is a process of authentication of a sample or an object capable of having been labelled with a particular mixture or combination of n assembled structures or n microparticles or nanoparticles according to the present invention, characterised in that it comprises the following steps:
the observation or analysis of the fluorescence spectrum emitted by the sample or the object capable of being thereby labelled; and
the comparison of the spectrum thereby obtained with the specific fluorescence spectrum associated with said mixture or combination,
the sample or the object being determined as authentic if the two spectra thus compared are identical.

Under yet another novel aspect, the present invention comprises an object or liquid characterised in that it is labelled with a specific mixture or combination of n assembled structures or n microparticles or nanoparticles according to the invention.

Under yet another novel aspect, the subject matter of the present invention is the use of a specific mixture or combination of n assembled structures or n microparticles or nanoparticles according to the present invention as biolabel, in particular for proteomic analysis, genome analysis, diagnosis in synthetic chemistry, environmental diagnosis, traceability or authentication of objects, for combatting counterfeits.

Finally, the subject matter of the present invention is a process for analysing or detecting the presence of at least one assembled structure or microparticle or nanoparticle, or a mixture of n assembled structures or n microparticles or nanoparticles, capable of generating an original fluorescence signal obtained according to the invention or capable of being obtained by a process according to the present invention, characterised in that it implements a reading of the fluorescence spectrum resulting from the separation of the hydrophobic and hydrophilic phase of the particle by identification of each spectral component of said two phases, said fluorescence spectra of each of the components being specific to the particle analysed.

The applications of fluorescent particles may be also numerous in public health and industrial sectors such as food processing, environmental management, or chemistry.

One may further cite as application their use in flux cytometry, in immunoassay, in cellular imaging and microscopy.

This technology makes it possible to generate in an advantageous manner specific and unique combinatories of these assembled chemical structures such as unique combinations of particles. These mixtures of particles generate an unfalsifiable colour code that can be analysed by fluorescence reading.

Also in an advantageous manner, the labelling is invisible to the eye and specific (unique molecular combinatory), natural and easily detectable by a fluorescence reading which may be portable.

The present invention also has the advantage of being able to encapsulate multiplexed fluorescent substances in an innovative manner by compartmentation thanks to the hydrophilicity or hydrophobicity properties of the latter. This novel method of encapsulation of fluorescent substances makes it possible to propose the use of numerous natural plant substances, which constitutes an advantage of this invention.

The figures, for which the captions are given hereafter, and the examples that follow are intended to illustrate the invention without however limiting its scope.

### FIGURE CAPTIONS

FIGS. 1A-1C: Observation under ultra-violet lamp of solutions of B1 extract, fluorescein (F) and a B1 extract/fluorescein (M) mixture,

FIG. 1A: Solution of B1 extract, fluorescein (F) and B1 extract/fluorescein (M) mixture, lv/lv and placed under the lighting of an ultra-violet lamp.

FIG. 1B: After synthesis of the particles, the solutions are centrifuged in order to separate the pellets from the supernatant containing the substances in excess. The supernatants are recovered and observed under an ultra-violet lamp.

FIG. 1C: The particles after synthesis are pelletized by centrifugation then re-suspended in a solution of 0.1% PVA. This type of rinsing is repeated twice before carrying out a final centrifugation and observing the pellet of particles and the remainder of particles in suspension under an ultra-violet lamp.

FIGS. 2A-2B: Observation of composite particles on slides on fluorescence microscope.

FIG. 2A: Composite particles of PMMA enriched with B1 extract containing hydrophobic fluorescent plant substances observed at a 40× magnification under a fluorescence microscope. The emission of fluorescence is analysed under a B2A filter (excitation >410 nm, stop filter: 515 to 560 nm).

FIG. 2B: Composite particles of PMMA enriched with fluorescein after synthesis of the particles, the solutions are centrifuged in order to separate the pellets from the supernatant containing the substances in excess. The supernatants are recovered and observed under an ultra-violet lamp.

FIGS. 3A-3B: Observation under ultra-violet lamp of colloidal solutions of different preparations of liposomes.

FIG. 3A: Colloidal solutions of different preparations of liposomes: unlabelled liposomes (V), liposomes containing the B1 extract (B1), liposomes containing a solution of fluorescein (F) and liposomes containing both the B1 extract and a solution of fluorescein (M).

FIG. 3B: Colloidal solutions of different preparations of liposomes specified in A after dialysis. S is a dialysate fraction of M.

FIGS. 4A-4B: Confocal images of PF capsules (green path uniquely: 500-620 nm, scale bar: 10 μm). (A) three typical capsules, (B) zoom on a capsule of around 10 μm diameter.

FIG. 5: Confocal image of PA capsules (green path: 500-620 nm, green path: 630-800 nm, scale bar: 10 μm)

FIGS. 6A-6B: Confocal images of APF capsules (scale bar: 10 μm). (A) green path uniquely: 500-620 nm, (B) red path uniquely: 630-800 nm

FIG. 7: Emission spectra typical of different types of capsules under excitation at 488 nm

FIGS. 8A-8E: Emission spectra obtained with the aid of a spectrofluorimeter, after an excitation at 488 nm

FIG. 8A: Spectrum of particles enriched with fluorescein

FIG. 8B: Spectrum of a solution of fluorescein

FIG. 8C: Spectrum of particles enriched with hydrophobic substances

FIG. 8D: Spectrum of hydrophobic substances in dichloromethane

FIG. 8E: Spectrum of particles enriched with fluorescein and with hydrophobic substance.

FIG. 9A-9D: “Water in oil” and “oil in water” solutions

FIG. 9A: “water in oil” solutions: (1) solution of hydrophobic substances; (2) after addition of 100 μL of fluorescein (10 mg/mL) in 900 μL of hydrophobic substances (12.5 mg/mL); (3) emulsion generated after agitation (vortex) of the mixture presented in (2)

FIG. 9B: “oil in water” solutions: (4) mixture of 100 μL of hydrophobic substances in 900 μL of fluorescein; (5) emulsion generated after agitation (vortex) of the solution in (4)

FIG. 9C: Spectrum corresponding to the spectrum of the “water in oil” emulsion displayed in FIG. 9A (C)

FIG. 9D: Spectrum corresponding to the “oil in water” emulsion spectrum displayed in FIG. 9B (D)

FIG. 10: Photograph of a kinetic obtained for a “water in oil” emulsion after agitation every two minutes. A photograph is taken every 3 minutes (0 min (1), 3 min (2), 6 min (3), 9 min (4), 12 min (5).

### EXAMPLES

### Example 1

### Observations of Composite Particles Constituted of PMMA and Enriched with Fluorescein (Hydrophilic Molecule) and with B1 Extract (Hydrophobic Molecule)

The method for obtaining particles of polymethyl methacrylate (PMMA) is described by Alonso (1996).

PMMA solubilised beforehand in a solvent such as dichloromethane is mixed with a 98% plant extract composed of chlorophylls a and b (hydrophobic molecules) obtained by a treatment with chloroform of a 70° ethanolic extract enabling

This mixture (B1 extract) constitutes the phase that we name solvent/PMMA/extract. A solute (aqueous phase) containing hydrophilic fluorescent molecules such as fluorescein in mixture with the first (solvent/PMMA) makes it possible by sonication to create an emulsion of fine aqueous particles. This emulsion mixed with water then emulsified a second time by sonication then leads to fine particles in suspension in water (from 50 nm to 10 μm). The latter are constituted of a shell of PMMA/B1 extract containing small globule(s) of solute(s). The solvent is evaporated by agitation thereby creating solid particles.

PMMA powder (250 mg) is dissolved in 5 ml of pure dichloromethane. If the particles are enriched with B1 extract, then 1 ml of 25 mg/ml (chloroform) B1 extract is poured into the solution of PMMA. To this latter solution is added 1 ml of water or a solution of fluorescein (3 mM/ml). The whole is passed into the sonicator in order to obtain a very fine emulsion. The emulsion is then poured into a large volume of a 0.1% PVA solution (500 ml). The whole is placed under agitation for 16 h under an exhaust hood in order to totally evaporate the solvent. Then, the particles are recovered by centrifugation at 6000 rpm (“rpm” for revolutions per minute) for 20 minutes. The supernatant is eliminated and the pellet taken up with a 0.1% PVA solution. Two centrifugations are repeated in order to eliminate any trace of B1 extract or fluorescein in the particle take up buffer.

### Example 2

### Epi-Fluorescence Observation on a Fluorescence Microscope and Under an Ultra-Violet Excitation Light of the Composite Particles Presented in Example 1

The particles are placed between slide and cover glass. Each mounting is sealed with the aid of paraffin.

The slides are then observed on a fluorescence microscope.

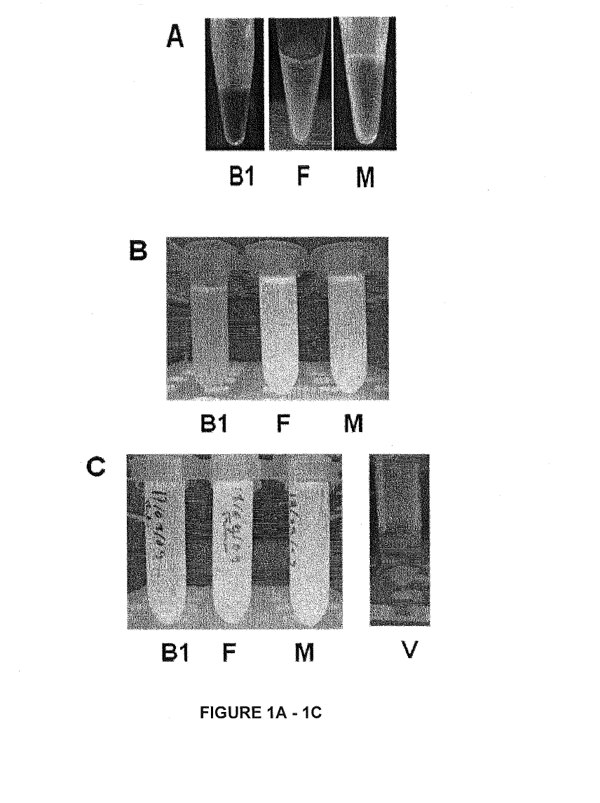

The observations reported in example 1 show that particles of PMMA containing a solution of water only generate a very weak fluorescence under ultra-violet (V in part C of the example 1). When the water is enriched with a fluorescent hydrophilic substance, fluorescein, then the particles of PMMA produce under ultra-violet a fluorescence emission, the yellow-green colour of which is characteristic of the latter (see FIGS. 1A-1C, tube “F”). When the organic phase containing the PMMA is enriched with the B1 extract (rich in hydrophobic substance(s) such as chlorophyll), the particles thereby produced emit under ultra-violet a fluorescence of red colour characteristic of the B1 extract ((see FIGS. 1A-1C, tube 5 “B1”). Finally, when the two types of fluorescent substances are used to generate particles, then the latter have an emission of fluorescence original and specific to this compartmentation, the resulting colour of which is orangey ((see FIGS. 1A-1C, tube “M”). To demonstrate the originality of this resulting emission, we have placed alone or in mixture the two types of fluorescent substances. Under ultra-violet we have observed the colour yellow-green of the fluorescein (“F”) FIG. 1A), red of the B1 extract (“B1”, FIG. 1A) and green-jade of the emulsified mixture (“M”, FIG. 1A). We confirm the green-jade emission of the mixture when we observe the different media after synthesis of the particles (FIG. 1B). The excess of non-encapsulated substances in the particles generates the green-jade colour of the mixture (“M”, FIG. 1B).

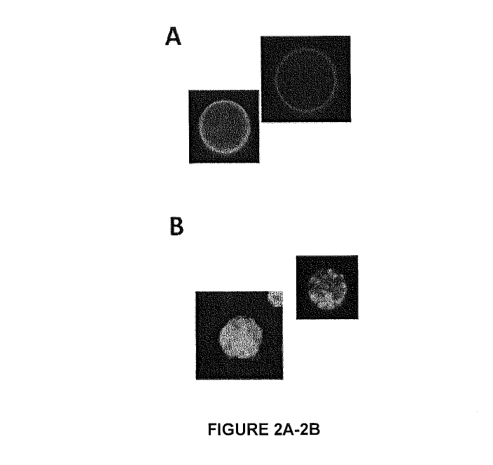

The effect of compartmentation is demonstrated by epifluorescence observations of the particles. The hydrophobic substances of the B1 extract are preferentially spread out at the periphery of the particles (in the shell) (see FIG. 2A) whereas the hydrophilic substance, fluorescein, is uniquely observed in the cavities of the particles (see FIG. 2B).

### Example 3

### Observations of Liposomes Charged with Fluorescein (Hydrophilic Molecule) and/or with B1 Extract (Hydrophobic Molecule(s))

The same type of observations indicated in examples 1 and 2 was acquired using the manufacture of liposomes. Liposomes are vesicles that form naturally or synthetically from concentrated phospholipids placed in the presence of an excess of water. The self-assembly of phospholipids into bilayer forms a membrane compartmentalising an aqueous intra-vesicular space. In this way, the lipidic membrane may be enriched with hydrophobic compound(s) such as the B1 extract and the content enriched with hydrophilic compound(s).

The method for obtaining liposomes is the injection in ethanol similar to that described by Thierry et al. (Thierry, A. R., Lunardi-Iskandar, Y, Bryant, J. L., Rabinovitch, P., Gallo, R. C., and Mahan, L. C.: Systemic gene therapy: biodistribution and long-term expression of a transgene in mice. Proc. Natl. Acad. Sci. USA. 92, 9742-5 9746, 1995).

For this experiment a solution of the following lipids, phosphatidylcholine, dimyristoyl-phosphatidylglycerol and cholesterol was prepared in ethanol with the weight ratio 16.5/4.3/9.2, respectively. 120 μl (3 mg total lipids) of this solution were injected into 1080 μl of sterile water. The labelled liposomes are obtained by adding before the mixing by injection of ethanolic and aqueous phases:
either a quantity of the plant fraction B1 (5 mg/ml) in the ethanolic phase
or a quantity of the solution of FITC (3 mmole/ml) in the aqueous phase
or a quantity of the plant fraction B1 (5 mg/ml) in the ethanolic phase and a quantity of the solution of FITC (3 mM/ml) in the aqueous phase.

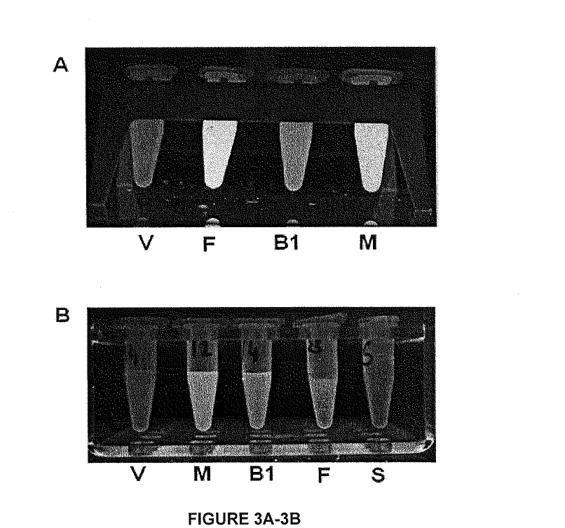

The different preparations of liposomes labelled and controlled are subjected after incubation of 1 hour at 25° C. to a first dialysis of 2 hours in bags with porosity of 160 000 d (Spectra) in distilled water at 25° C. Then the dialysis bags are subjected to a second dialysis of 12 hours at 25° C. The preparations are recovered in Eppendorf tubes then placed under UV to evaluate their emitted colour (See FIGS. 3 A-3B).

This example clearly confirms the preceding observations. The manufacture of another type of particle, namely liposomes, led to the same results. The latter structure two compartments; the hydrophobic layer constituted of lipids on the one hand and the aqueous content (hydrophilic substances) on the other hand. The liposomes prepared with the aid of the two substances exhibit under ultra-violet an orangey fluorescence emission (See FIG. 3B, tube “M” and example 3) very different to the red or green-yellow colour emitted by the particles obtained respectively with the plant B1 extract alone (see FIGS. 3 A and 3B, tube “B1” and of the example 3) or fluorescein alone (see FIGS. 3A and 3B, tube “F” and the example 3). In a remarkable manner, this resulting orangey colour is clearly different to the green-jade colour of the mixture before dialysis (see FIG. 3A, tube “M” and of the example 3)).

In light of the results obtained with the particles of PMMA and/or liposomes, the inventors have demonstrated and clearly shown that the process and its applications could be generalised to any assembled structure having a phase partition, such as any natural or synthetic environment making it possible to obtain the compartmentation of a hydrophilic space and a hydrophobic space, such as a composite particle or a liposome.

One may cite for example, but without being limited thereto, the use of three-dimensional polymeric networks such as polymer triblocks (solid materials or in gel form) containing by virtue of their composition a hydrophilic part and a hydrophobic part.

### Example 4

### Emission Spectra of these Different Mixtures

### A) Materials and Methods

The spectral confocal microscopy experiments presented in this section were carried out with the aid of LEICA TCS-SP2 laser scanning microscopy system (upright stand). The excitation was realised with the aid of an Argon laser at the wavelength of 488 nm with a power of the order of that normally used in the observation of immunohistochemistry labels conventionally encountered in biology (as an indication: laser at a quarter of its full power and acousto-optic filter allowing less than 20% of the laser line to pass). The objective used was an oil immersion, wide numerical aperture objective specially devised for fluorescence confocal microscopy (HCX PL APO CS 40.0×1.25 OIL). It enables work between slide and cover glass of 170 μm. The separation between excitation and emission (fluorescence) is achieved with the aid of an interferential dichroic mirror of RSP500 type (having a wavelength cut off at 500 nm). Thanks to this mirror, the incident laser at 488 nm is reflected towards the sample, but the return light (of wavelength greater than 488 nm) mainly passes through the mirror. This LEICA system enables a specific fluorescence band to be collected. Thus, this system enables a spectral resolution and a wavelength scanning of the collected fluorescence. In the images that will be presented, the green path will correspond to a collection of fluorescence between 500 nm and 620 nm and the red path to a collection of fluorescence between 630 nm and 800 nm. The spectra presented, for their part, will correspond to an acquisition by wavelength scanning from 500 nm to 800 nm with a 10 nm collection window. Each image presented is obtained by scanning of the excitation beam at a rate of 400 lines per second and corresponds to an average over several scannings of a same zone. These images are also confocal sections (virtual sections) and are thus obtained by collection of the fluorescence coming mainly from an axial plane of reduced thickness (of the order of a micron). At the working wavelength chosen and with the objective used, the theoretical resolution given by the manufacturer is of the order of 0.160 μm laterally and 0.9 μm axially. The samples are prepared from capsules in aqueous solution (with 0.1% of surfactant additive to avoid aggregation). After centrifugation of these solutions, around 1 μl of solution was taken from the bottom of the tubes and mixed with a drop of fluorescence microscopy mounting medium (Vectashield), then placed between slide and microscopy cover glass.

### B) Results

For each lot of capsule supplied, several slides were prepared and observed under confocal microscope. No measurable fluorescence was able to be detected on the samples containing the polymer alone (without plant substance or fluorescein). The images presented in this part are a compilation of the most representative results.

### 1) Sample of PF Type (Fluorescein):

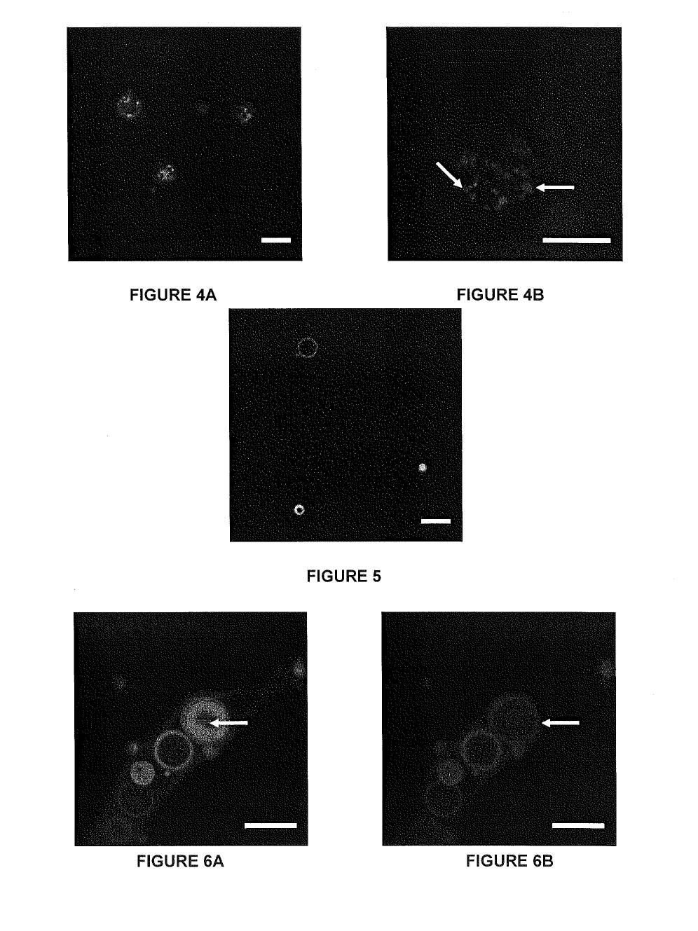

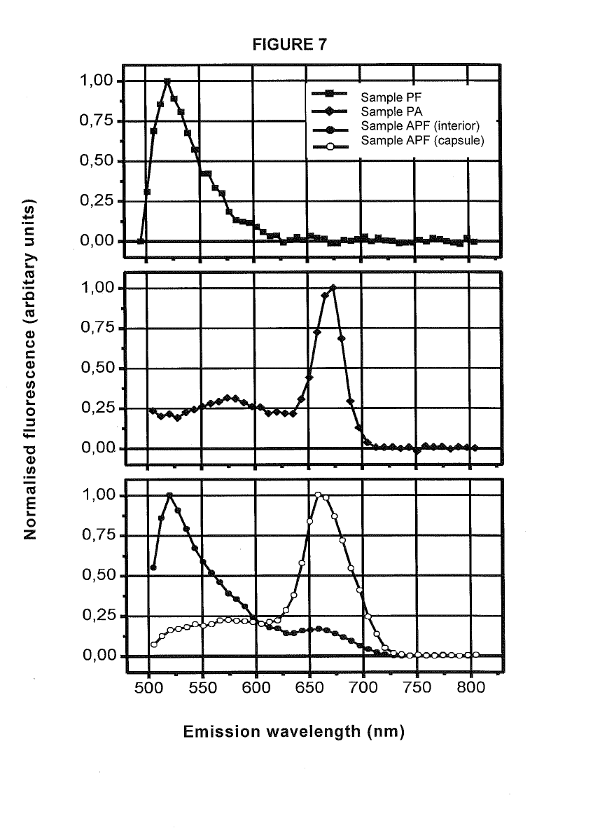

FIGS. 4A and 4B present the capsules typically observed on the PF samples. Only the green path is presented because no significant fluorescence was able to be observed above 630 nm. In the results of the spectral study illustrated in FIG. 7, one finds a fluorescence typical of fluorescein with a maximum around 530 nm. The remarkable feature of these samples is the inhomogeneous distribution of the fluorescent substance in the particles of polymer corresponding to the cavities of the latter. A zoom on a large particle of around 10 μm diameter and presented in FIG. 1B illustrates this inhomogeneity. On this particle, the fluorescence appears in zones of the order of or less than a micron (see arrows in FIG. 1B).

### 2) Sample of PA Type (Hydrophobic Plant Substance):

FIGS. 5A and 5B present three particles typically observed on samples of PA type. One notes the presence of solid or hollow particles, with more or less extended cavities. The image is a superposition of the red path and of the green path. This time, the distribution of the fluorescence is homogeneous within the polymer corresponding to the shell of the latter. A weak fluorescence is noted in the green path and a stronger fluorescence in the red path. By playing on the sensitivities of the detectors of these two paths, one manages to balance the luminosity of the images and one thus obtains capsules that appear in yellow.

More precisely, the emission spectrum of these capsules is shown in FIG. 7. One notes effectively two bands of fluorescence of different levels: a not very intense and quite wide band which extends from green to orange (between 500 nm and 625 nm), then a more intense and narrower band in the red from 625 to 725 nm corresponding to the spectrum expected of chlorophylls.

### 3) Sample of APF Type (Plant Substance and Fluorescein Mixture):

FIGS. 6A and 6B represent finally the particles obtained following a mixing of the two substances evoked previously (fluorescein and plant substance). For purposes of clarity, the two red and green paths have not been superimposed here. One notes a compartmentation of the two hydrophilic (fluorescein) and hydrophobic (plant substance) substances. The hydrophobic substance inserts itself into the shell of the particle indicated by an arrow on the red path of FIG. 6. The hydrophilic substance occupies for its part the inside of the particle (green path). The two spectral curves presented in FIG. 7 corroborate this affirmation. In fact, the spectra have been plotted by choosing as region of interest on the series of spectral images, either a ring 15 pixels wide integrating the pixels of the shell, or a disc integrating the interior pixels. For the interior region of interest, one finds again almost exclusively the spectrum obtained with the PF capsules (fluorescein) and for the exterior region, a spectrum very similar to the spectrum obtained for the PA particles. Furthermore, it should be noted that this compartmentation is not observed for all the particles. As for the PA sample, one finds particles more or less empty, but where only the fluorescence measured on the PA samples (characteristic of the plant substance) appears. It thus seems that these particles do not contain fluorescein.

### Example 5

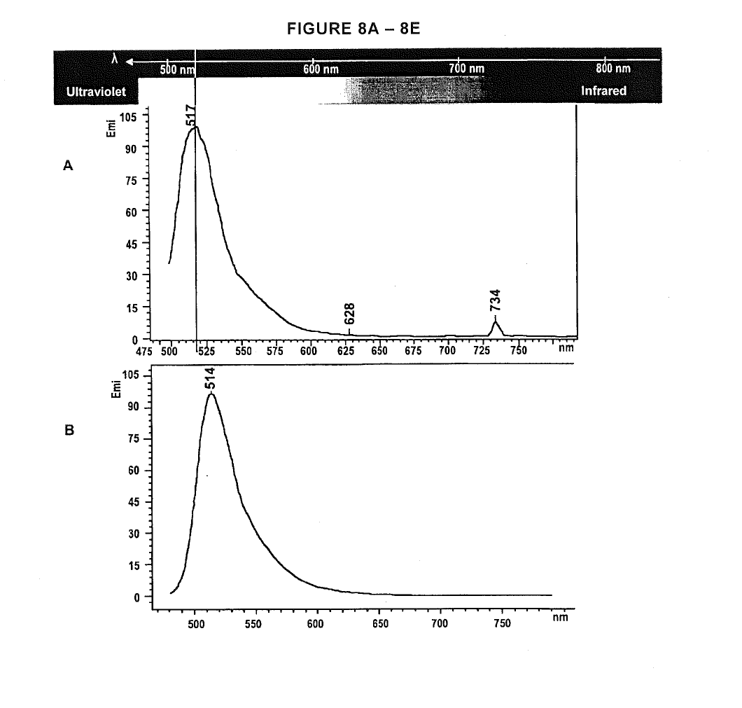

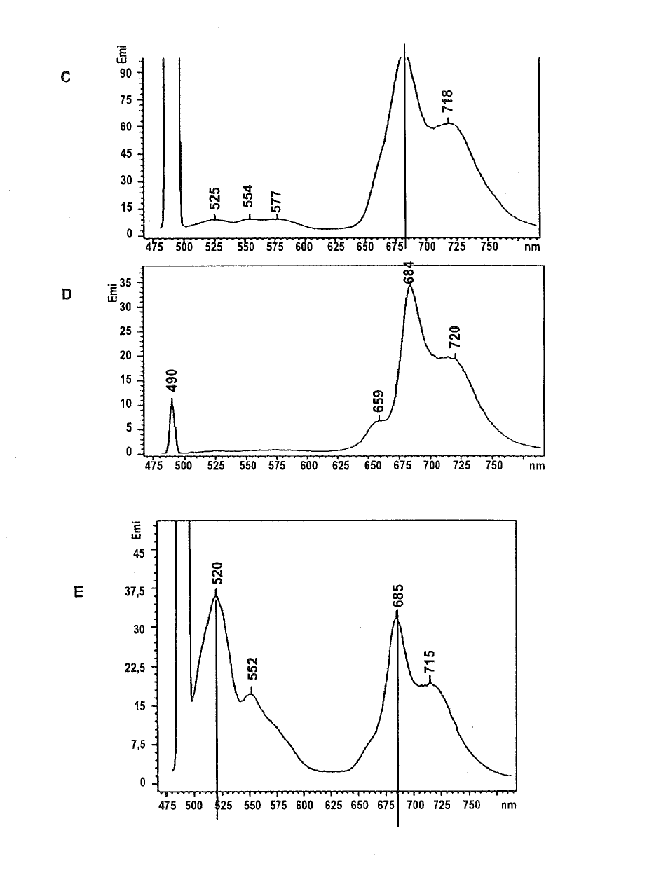

### Emission Spectra Obtained with the Aid of a Spectrofluorimeter, after an Excitation at 488 nm (See FIGS. 8A-8E)

The particles (solid composite and fluorescent structures) were suspended in water (1 mg of particles in 500 μL). Spectrum of particles enriched with fluorescein (5 mg/mL) (A); spectrum of a solution of fluorescein (10 mg/mL) (B); spectrum of particles enriched with hydrophobic substances (chlorophylls in particular at 12.5 mg/mL) (C); spectrum of hydrophobic substances in dichloromethane (12.5 mg/mL) (D); spectrum of particles enriched with fluorescein and with hydrophobic substances (E).

This example highlights the possibility of obtaining the fluorescence emission spectra of composite structures in suspension in water under an excitation light of 488 nm, with the similarity of the spectra obtained for fluorescein (hydrophilic substance) pure or coated (514 nm max) (at the core of the composites structures).

These results demonstrate that the polymer is not involved in the phenomenon described above. Composite structures that contain only hydrophobic substances (chlorophylls in particular) positioned in the periphery generate a spectrum with two emissions; one at 660 nm and the other at 720 nm, this spectrum representing the specific signature of this structure.

Finally, this example highlights that the compartmented composite structures containing both hydrophilic (such as fluorescein) and hydrophobic (such as chlorophyll in particular) substances generate an original spectrum with 4 characteristic fluorescences: at 520 nm, at 562 nm and 680 nm and 715 nm. The spectrum reveals essentially an obvious modification of the emission of fluorescein; it seems to lose all of its intensity at 514 nm with a shift of the emission spectrum towards higher wavelengths (520/562 nm). This result is in agreement with the measurements of the emission spectra obtained in fluorescence confocal microscopy.

In view of these results, it could be accepted that the hydrophobic substances in the periphery absorb a large part of the light emitted by fluorescein in the green. This reinforces the effect of position within the particle (composite structure). But in addition, secondly, the light emitted by the fluorescein is going to be re-absorbed in part by the hydrophobic substances which will have the consequence of reinforcing the emission intensity thereof.

### Example 6

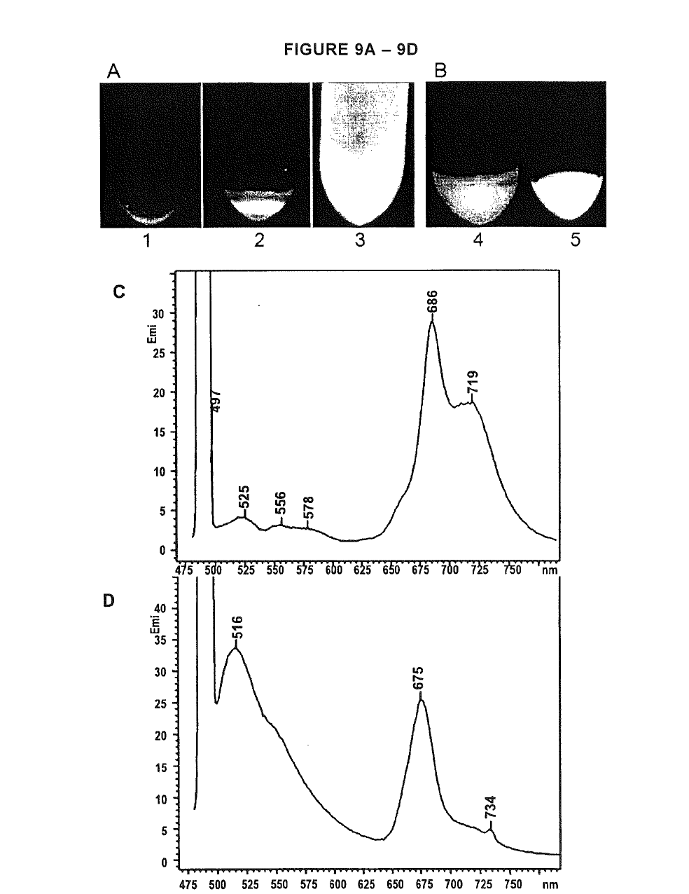

### Description of the Fluorescence Properties of Emulsions Obtained with the Aid of an Aqueous Solution of Fluorescein (10 mg/mL) and a Solution of Hydrophobic Substances (Chlorophylls and Phenolic Derivatives at 12.5 mg/mL in Dichloromethane) (See FIGS. 9A-9D)

In the formation of emulsions, we will name “water” the solution of fluorescein and “oil” the solution enriched with chlorophylls. “Oil” in “water” emulsions are formed by mixing 100 μL of the solution enriched with chlorophylls in 900 μL of the fluorescein solution. Conversely, a “water” in “oil” emulsion was formed; the latter corresponding to said composite structures.

### “Water in Oil” Solutions:

1) solution of hydrophobic substances (see FIG. 9A(1))
2) after addition of 100 μL of fluorescein (10 mg/mL) in 900 μL of hydrophobic substances (12.5 mg/mL) (see FIG. 9A(2));
3) emulsion generated after agitation (vortex) of the mixture presented in (2) (see FIG. 9A(3));

### “Oil in Water” Solutions:

4) mixture of 100 μL of hydrophobic substances in 900 μL of fluorescein (see FIG. 9B(4)); and
5) emulsion generated after agitation (vortex) of the solution in (4) (see FIG. 9B(5)).

The corresponding spectra were obtained for:
The spectrum of the “water in oil” emulsion displayed in (3) (see FIG. 9C); and
The spectrum of the “oil in water” emulsion displayed in (5) (see FIG. 9D)

This example shows the results obtained from a very simple experiment where the polymer has been removed from the mixture; “water in oil” and/or “oil in water” emulsions are thereby obtained. The “water in oil” emulsion corresponding to these composite structures presented previously generate an orange colour under UV, whereas conversely “oil in water” generates a green jade colour which corroborates the first observations. The spectra obtained reinforce the interpretation made previously since spectra identical to the composite structures studied in the preceding example are found once again.

In this example is presented the very important spectrum of the “oil in water” emulsion with the fluorescein this time in the periphery and the hydrophobic substances at the core of the structure. In these conditions a spectrum that exhibits 3 wavelengths is obtained:
one corresponding to the emission of the fluorescein (510/520 nm); and
the other two corresponding to the hydrophobic substances (at 660/680 and at 720/740 nm).

It may thereby be concluded that the reverse “oil in water” emulsion emits a fluorescence and generates a spectrum that is the consequence of the fluorescences of the substances in the mixture.

### Example 7

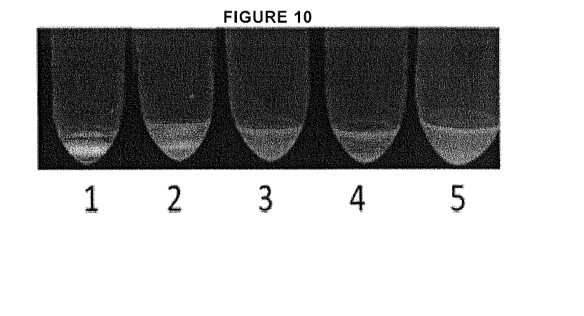

### “Water in Oil” Emulsion (See FIG. 10)

In this example, a “water in oil” emulsion was formed by mixing 150 μL of fluorescein (10 mg/mL) in 900 μL of hydrophobic substances (25 mg/mL) in dichloromethane.

A kinetic was carried out at ambient temperature and agitating every two minutes (vortex). A photograph was taken every 3 minutes (0 min (see FIG. 10 (1)), 3 min (see FIG. 10 (2)), 6 min (see FIG. 10 (3)), 9 min (see FIG. 10 (4)) and 12 min (see FIG. 10 (5))).

This example highlights the instability of the fluorescence generated by the emulsions; between 4 to minutes after obtaining the latter, the fluorescence decreases rapidly up to total extinction. It is probable that a very rapid decomposition of the substances takes place on contact with aggressive solvents. Furthermore, the hydrophilic and hydrophobic substances taken separately to produce emulsions are going to manifest the same instability over time, which reinforces the preceding interpretation.

Knowing that the substances taken in their respective solubilisation media are stable and that the same holds for composite structures, it appears clearly and certain that no phenomenon of the “quenching type is at play here. Thus, the processes of the invention as described make it possible to create solid composite structures with the aid of polymer and/or lipids thereby generating a physical barrier between non-miscible substances in solution and incapable of mixtures, as is shown in the example.

With regard to all of the preceding examples, the subject matter of the present invention is a composition (and a process aiming to obtain it) capable of generating original fluorescent composite structures. The claimed process makes it possible to create (to obtain) said composite structure by producing an emulsion, a particle or a liposome with the aid of an aqueous solution of hydrophilic substances (such as fluorescein) and a solvent containing the hydrophobic substances (such as chlorophyll in particular) and the polymer (such as PMMA) or lipids not miscible with water. These solid composite and fluorescent structures generate totally original and stable emission spectra.

The fluorescence spectrum thereby obtained with these structures is not the consequence of superposition of the emission spectra of each substance. This observation and these results highlight a specificity of this spectrum closely linked to the choice of substances on the one hand and to the manufacture of the structures themselves on the other hand.

These examples and results highlight the fundamental importance of the organisation of the composite structures in particular the mapping of substances within the latter. The excitation light reaches the substances sequentially with original emissions/absorptions.

### REFERENCES

Huang B, Bâtes M, Zhuang X. Super-resolution fluorescence microscopy. Annu Rev Biochem. (2009) 78 pp 993-1016.
Fomüsek L, Vëtvicka V. Polymeric microspheres as diagnosis tools for cell 5 surface marker tracing. Crit Rev Ther Drug Carrier Syst. (1986) 2(2) pp 137-74.
Sukhanovaa A, Devya J, Venteoa L, Kaplana H, Artemyeva M, Oleinikova V, Klinovc D, Pluota M, Cohena and Igor Nabiev J H M. Biocompatible fluorescent nanocrystals for immunolabeling of membrane proteins and cells. Analytical Biochemistry (2004) vol. 324, Issue 1, pp 60-67.
Burroughes J H, Bradley D D C, A. R. Brown, Marks R N, Mackay K, Friend R H, Bums P L and Holmes A B. Light-emitting diodes based on conjugated polymers. Nature (1990) vol. 347, no6293, pp 539-541.
Akao T, Kimura T, Hirofuji Y S, Matsunaga K, Imayoshi R, Nagao J, Cho T, Matsumoto H, Ohtono S, Ohno J, Taniguchi K, Kaminishi H. A poly(gamma-glutamic 15 acid)-amphiphile complex as a novel nanovehicle for drug delivery system. J Drug Target. (2010) August; 18 (7): 550-6
Chooi K W, Gray A I, Tetley L, Fan Y, Uchegbu I F. The molecular shape of poly(propylenimine) dendrimer amphiphiles has a profound effect on their self assembly. Langmuir. (2010) February 16; 26(4): 2301-16.
Black J K, Tracy L E, Roche C P, Henry P J, Pesavento J B, Adalsteinsson T. Phase transitions of hexadecane in poly(alkyl methacrylate) core-shell microcapsules. J Phys Chem B. (2010) April 1; 114(12):4130-7.
Sakai T, Ishigaki M, Okada T, Mishima S. (2010). A facile route of gold nanoparticle synthesis and surface modification using amino-terminated poly(ethylene oxide)-poly(propylene oxide) block copolymers. J Nanosci Nanotechnol. February; 10(2): 919-26.
Hench, L. L., and Polak, J. M. Third-generation biomedical materials. Science. (2002) 295:1014-1017.
Hoogeveen, N. G., Cohen Stuart, M. A., Fleer, G. J., and Bohmer, M. R. Formation and Stability of Multilayers of Polyelectrolytes. Langmuir. (1996) 12: 3675-3681.
Cartier R, Kaufner L, Paulke B R, Wüstneck R, Pietschmann S, Michel Bruhn H and Pison U. Latex nanoparticles for multimodal imaging and detection vivo. Nanotechnology. (2007). Volume 18, 19: 195102.

1. Process for preparing in partition phase an assembled chemical structure having a compartmentation capable of generating a specific fluorescence signal in phase partition, said phase partition delimiting a first compartment and a second compartment, said first compartment and said second compartment not being miscible together, said process comprising the following steps:
a) the preparation of the non-miscible first phase and the second phase; and
b) the formation of said assembled chemical structure having as consequence of the phase partition a first compartment and a second compartment not miscible together,
characterised in that said first compartment contains a composition comprising at least one compound miscible in said first phase capable of generating a fluorescence and the second compartment contains a composition comprising at least one compound miscible in said second phase capable of generating a fluorescence.

2. Process for preparing an assembled chemical structure according to claim 1, characterised in that said phase partition delimits a first compartment of hydrophobic nature and a second compartment of hydrophilic nature, said process comprising the following steps:
a) the preparation of the phase of hydrophobic nature not miscible with water and the phase of hydrophilic nature, and
b) the formation of said assembled chemical structure having as consequence of the phase partition a hydrophobic compartment and a hydrophilic compartment,
characterised in that:
said hydrophobic phase contains a composition comprising at least one hydrophobic compound capable of generating a fluorescence (known as hydrophobic fluorescent compound) and the hydrophilic phase contains a composition comprising at least one hydrophilic compound capable of generating a fluorescence (known as hydrophilic fluorescent compound); or
said hydrophobic and hydrophilic phases are mixed with a third amphiphile containing a composition comprising at least one hydrophobic fluorescent compound and at least one hydrophilic fluorescent compound.

3. Process for preparing an assembled chemical structure according to claim 1 or 2, characterised in that said process is a process for preparing microparticles or nanoparticles capable of generating a specific fluorescence signal, said microparticles or nanoparticles comprising a rigid or fluid wall delimiting at least one intra-particular space, said wall being of hydrophobic nature and said intra-particular space being occupied by an aqueous solution, or, conversely said wall being of hydrophilic nature and said intra-particular space being occupied by a solution of hydrophobic nature, said process implementing a process for preparing microparticles or nanoparticles comprising the following steps:
a) the preparation of an organic solution not miscible with water (named hydrophobic solution) and an aqueous solution;
b) the placing in contact of the hydrophobic solution with the aqueous solution; and
c) the formation of said particles,
characterised in that:
said hydrophobic solution contains a composition comprising at least one hydrophobic compound capable of generating a fluorescence (named hydrophobic fluorescent compound) and the hydrophilic solution contains a composition comprising at least one hydrophilic compound capable of generating a fluorescence (named hydrophilic fluorescent compound); or
said hydrophobic and hydrophilic solutions are mixed with a third containing a composition comprising at least one hydrophobic fluorescent compound and at least one hydrophilic fluorescent compound.

4. Process for preparing microparticles or nanoparticles according to claim 3, characterised in that the microparticles or nanoparticles are composites/synthetic particles and in that the process implemented for the preparation of these microparticles or nanoparticles is the process of double emulsion-evaporation of solvent enabling the encapsulation in said particles of said at least hydrophilic and hydrophobic fluorescent compound and the process of single emulsion-evaporation of solvent enables the encapsulation in said particles of said at least hydrophobic fluorescent compound.

5. Process for preparing microparticles or nanoparticles according to claim 4, characterised in that the process implemented for the preparation of microparticles or nanoparticles is the process of double emulsion-evaporation of solvent.

6. Process for preparing microparticles or nanoparticles according to claim 5, characterised in that said hydrophobic solution is constituted of a solution selected from:
a solution of polymethyl methacrylate (PMMA) dissolved in dichloromethane;
polycaprolactone dissolved in acetone; or
polystyrene dissolved in limonene or chloroform.

7. Process for preparing liposomes according to claim 2, characterised in that the process implemented for the preparation thereof implements as hydrophobic solution a concentrate of phospholipids.

8. Process according to one of claims 1 to 7, characterised in that:
said composition comprising at least one compound miscible in the first phase capable of generating a fluorescence and said composition comprising at least one compound miscible in the second phase capable of generating a fluorescence; or
said composition comprising at least one hydrophobic compound capable of generating a fluorescence and said composition comprises at least one hydrophilic compound capable of generating a fluorescence,
is selected from the group constituted of a synthetic or natural, plant or animal extract, a mixture of synthetic and/or natural extracts, an isolated or purified hydrophobic or hydrophilic compound capable of generating a fluorescence, and a mixture of said isolated or purified compounds.

9. Process according to claim 8, characterised in that said composition comprising at least one hydrophobic fluorescent compound is constituted essentially of the hydrophobic part of a plant or animal extract, or a mixture thereof, and in that said composition comprising at least one hydrophilic fluorescent compound is constituted essentially of the hydrophilic part of a plant or animal extract, or a mixture thereof.

10. Process for preparing microparticles or nanoparticles according to claim 9, characterised in that said hydrophobic part and said hydrophilic part are taken from the same extract or from two separate extracts.

11. Process for preparing a mixture of at least two assembled chemical structures or preparation of a mixture of at least two microparticles or nanoparticles capable of generating a specific fluorescence signal that is significantly different (capable of being distinguished from each other), each of said assembled chemical structures or said microparticles or nanoparticles being obtained by a process according to one of claims 1 to 10, characterised in that:
one at least of the compounds capable of generating a fluorescence and miscible in the first phase, and one at least of the compounds capable of generating a fluorescence and miscible in the second phase contained in said assembled structure is different between said two assembled structures; or
one at least of the hydrophobic or hydrophilic fluorescent compounds contained in said particle is different between said two micro- or nanoparticles.

12. Process for preparing a mixture of at least n assembled chemical structures or for preparing a mixture of at least n microparticles or nanoparticles capable of generating a specific fluorescence signal significantly different between said n assembled structures or particles or liposomes, each of said assembled structures or microparticles or nanoparticles being obtained by a process according to one of claims 1 to 11, characterised in that it implements for each of said assembled structures or particles or liposomes a composition in compounds capable of generating a different fluorescence for each of said assembled structures or particles or liposomes, and in that n is greater than or equal to 2.

13. Assembled structures or microparticles or nanoparticles, or mixture of assembled structures or microparticles or nanoparticles, capable of generating a specific fluorescence signal obtained by a process according to one of claims 1 to 12.

14. Mixture of at least n microparticles or nanoparticles, capable of generating a specific fluorescence signal different between each of said particles, characterised in that each of said particles comprises:
a rigid or fluid wall delimiting at least one intra-particular space, said wall being of hydrophobic nature and said intra-particular space being occupied by an aqueous solution, or, conversely said wall being of hydrophilic nature and said intra-particular space being occupied by a solution of hydrophobic nature;
i) when said rigid or fluid wall is of hydrophobic nature and said intra-particular space is of hydrophilic nature, said wall comprises at least one hydrophobic fluorescent compound and said intra-particular space comprises at least one hydrophilic fluorescent compound,
ii) when said rigid or fluid wall is of hydrophilic nature and said intra-particular space is of hydrophobic nature, said wall comprises at least one hydrophilic fluorescent compound and said intra-particular space comprises at least one hydrophobic fluorescent compound; and in that:
for each of said n microparticles or nanoparticles, one at least of the hydrophobic or hydrophilic fluorescent compounds contained in said rigid or fluid wall and/or in said intra-particular space is different between these n particles, and
n being greater than or equal to 2.

15. Mixture of at least n microparticles or nanoparticles according to claim 13 or 14, characterised in that said particles are selected from composites/synthetic particles.

16. Mixture of at least n microparticles or nanoparticles according to one of claims 14 to 15, characterised in that said particles are particles in which said rigid or fluid wall is of hydrophobic nature and said intra-particular space is of hydrophilic nature.

17. Mixture of at least n microparticles or nanoparticles according to one of claims 14 to 16, characterised in that said particles are synthetic particles in which the wall is constituted essentially of polymers selected from polymethyl methacrylate (PMMA), polycaprolactone, polystyrene, latex, cellulose, chitosan, viscose.

18. Mixture of at least two assembled structures or microparticles or nanoparticles according to one of claims 13 to 17, characterised in that
said composition comprising at least one compound miscible in the first phase capable of generating a fluorescence or said composition comprising at least one compound miscible in the second phase capable of generating a fluorescence; or
said composition comprising at least one hydrophobic compound capable of generating a fluorescence or said composition comprising at least one hydrophilic compound capable of generating a fluorescence,
is selected from the group constituted of a synthetic or natural, plant or animal extract, or a mixture of synthetic or natural extracts, an isolated or purified hydrophobic or hydrophilic compound capable of generating a fluorescence, or a mixture of said isolated or purified compounds.

19. Mixture of at least two assembled structures or microparticles or nanoparticles according to one of claims 13 to 18, characterised in that said composition comprising at least one hydrophobic compound capable of generating a fluorescence is constituted essentially of the hydrophobic part of a plant or animal extract, or a mixture thereof, and in that said composition comprising at least one hydrophilic compound capable of generating a fluorescence is constituted essentially of the hydrophilic part of a plant or animal extract, or a mixture thereof.

20. Mixture of at least n assembled structures or n microparticles or nanoparticles according to one of claims 13 to 19, characterised in that said hydrophobic part and said hydrophilic part within a same particle are taken from the same extract or two separate extracts.

21. Composition for in vivo diagnosis or for in vivo medical imaging, characterised in that it comprises a mixture of at least n assembled structures or n microparticles or nanoparticles according to one of claims 13 to 20.

22. Composition according to claim 21, characterised in that the external wall of said particle is labelled with the aid of a specific label of the biological tissue or the cell, or one of the elements thereof that one wishes to observe or highlight, each of the n particles being labelled with the aid of a different label between each of the particles.

23. Kit for in vitro diagnosis, characterised in that the kit comprises a mixture of at least n assembled structures or n microparticles or nanoparticles according to one of claims 13 to 20, each of the assembled structures or particles being preferably labelled with a different label.

24. Composition according to claim 22 or kit according to claim 23, characterised in that said label is a biological label capable of attaching itself specifically onto the element that it is wished to highlight or observe, in particular an antibody directed specifically against said element.

25. Process for labelling a sample or an object characterised in that said sample or object is placed in contact with a mixture of n assembled structures or n microparticles or nanoparticles according to one of claims 13 to 20.

26. Process for labelling a sample or an object according to claim 25, characterised in that the object is comprised in the group of objects constituted of a work of art, technical parts of high added value, manufactured objects.

27. Process for labelling a liquid composition characterised in that one incorporates in said composition a mixture of assembled structures or n microparticles or nanoparticles according to one of claims 13 to 20, in particular said composition being selected from an ink, an injectable liquid or a nutritive solution.

28. Process for diagnosis, in particular of a pathology or a stage of advancement or regression of a pathology, from a biological sample, characterised in that it implements a step in which one places in contact a mixture of n assembled structures or n microparticles or nanoparticles according to one of claims 13 to 20 with said sample and in that one observes or analyses the fluorescence spectrum emitted by the sample thereby labelled, in particular at the level of certain elements of the sample, preferably from a biopsy.

29. Process of authenticating a sample or an object capable of having been labelled with a particular mixture or combination of n assembled structures or n microparticles or nanoparticles according to one of claims 13 to 20, characterised in that it comprises the following steps:
the observation or analysis of the fluorescence spectrum emitted by the sample or the object capable of being thereby labelled; and
the comparison of the spectrum thereby obtained with the specific fluorescence spectrum associated with said mixture or combination,
the sample or the object being determined as authentic if the two spectra thereby compared are identical.

30. Object or liquid characterised in that it is labelled with a specific mixture or combination of n assembled structures or n microparticles or nanoparticles according to one of claims 13 to 20.

31. Use of a specific mixture or combination of n assembled structures or n microparticles or nanoparticles according to one of claims 13 to 20 as biolabel, for proteomic analysis, genome analysis, diagnosis in synthetic chemistry, environmental diagnosis, object traceability or authentication, or for combatting counterfeits.

32. Process for analysing or detecting the presence of at least one assembled structure or microparticle or nanoparticle, or a mixture of n assembled structures or n microparticles or nanoparticles, according to one of claims 13 to 20, said assembled structure or said particle being capable of generating an original fluorescence signal, characterised in that it implements a reading of the fluorescence spectrum resulting from the separation of the hydrophobic and hydrophilic phase of the particle by laser confocal microscopy in order to enable the identification of each spectral component of said two phases, said fluorescence spectra of each of the components being specific to the particle analysed.
